(19) United States
(12) Patent Application Publication
(10) Pub. No.: US 2006/0059441 A1
(43) Pub. Date: Mar. 16, 2006

(54) System and method for displaying a graphical tree hierarchy

(76) Inventor: Stephen James Todd, Winchester (GB)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/223,001

(22) Filed: Sep. 9, 2005

(30) Foreign Application Priority Data
Sep. 10, 2004 (GB) 0420086.1

(51) Int. Cl. G06F 3/00

(52) U.S. Cl. 715/853; 715/734; 715/713; 715/854

(57) ABSTRACT

A data processing system comprises a display device for displaying graphical information, a user interface device for receiving user input, and a processor communicating with the user interface for receiving the user input and communicating with the display device for controlling the output of the display device. The processor is arranged to display on the display device a tree hierarchy comprising a series of nodes, and to change the display of the tree hierarchy in response to user input. The processor is further arranged, in response to a defined user input, to change the display of the tree hierarchy to split the tree hierarchy into two sections, with a visible indication between the two sections.

### BACKGROUND OF THE INVENTION

This invention relates to a data processing system and method for displaying a graphical tree hierarchy, and to a computer program product for carrying out the data processing method.

In many types of data processing systems, a large number of objects, such as directories, folders, files and programs, can exist. In order for a user to sensibly view and/or access the various objects, they are typically arranged into a tree hierarchy. One example of such a structure is the Windows Explorer application, which creates a logical tree structure of the objects that can be accessed by a computer running the Windows Explorer application. These objects will be those stored on the computer's hard disk(s), and also objects that may be on removable media such as compact disks, and can include objects that are available via a network, being stored elsewhere.

When a user accesses Windows Explorer, they are presented with a view of the tree hierarchy and also a view of the contents of the currently selected object (if that object is a directory or folder), which will default to a particular object within the tree. The user can navigate the view of the tree hierarchy by expanding and contracting elements within the tree, selecting objects within the tree, and manipulating a scroll bar to scroll up and down the tree view, when it gets too large for all of it to be shown on the screen.

The Windows Explorer hierarchical tree has a number of disadvantages for the user. It wastes display area by displaying expanded details that the user no longer needs or in which they are no longer interested. As more branches of the tree are opened (or expanded), the tree expands. To manage the size of the tree, the user must periodically go through the tree and reselect an expanded entry to close the entry. Since most computers now have access to a very large number of objects, it is desirable to present the user with an improved navigational structure.

One such improved structure is disclosed in United States of America patent U.S. Pat. No. 6,236,400, which discloses a method and apparatus for controlling the display of hierarchical information. Embodiments of the invention display hierarchical information more efficiently. Hierarchical information is displayed in a vertical browser comprising a path list and a choices list. A choices list displays selection choices at a given hierarchical level. When a selection is made in the choices list, the selection is displayed in the path list. The choices list is updated to reflect the next hierarchical level. The path list displays a plurality of choices that represent the traversal path through the hierarchical information. Backwards traversal is possible by selecting an entry in the path list. The path list is updated to remove the selected entry and any successive entry. The hierarchical level that contains the path list entry is displayed in the choices list. The path and choices list can be independently sized and are automatically maintained to remove irrelevant information.

While this method for controlling the display of hierarchical information improves upon the known Windows Explorer display system, it has a number of serious weaknesses. It is not possible, within the method of this patent, to have more than one path to an object (a file or folder etc.) expanded at any one time, and the user cannot smoothly scroll between pre-expanded sections of the tree. It is not possible to view any information that is not relevant to the current selection they have made. The only way to see other parts of the tree is to navigate to a new object, but as soon as a user does this, they lose the view of the path to the object that they have previously been viewing.

### SUMMARY OF THE INVENTION

According to a first aspect of the invention there is provided a data processing system comprising a display device for displaying graphical information, a user interface device for receiving user input, and a processor communicating with the user interface for receiving the user input and communicating with the display device for controlling the output of the display device, the processor being arranged to display on the display device a tree hierarchy comprising a series of nodes, and to change the display of the tree hierarchy in response to user input, wherein the processor is further arranged, in response to a defined user input, to change the display of the tree hierarchy to split the tree hierarchy into two sections, with a visible indication between the two sections.

According to a second aspect of the invention there is provided a data processing method comprising displaying graphical information in the form of a tree hierarchy comprising a series of nodes, receiving user input, changing the display of the tree hierarchy in response to user input, and, in response to a defined user input, changing the display of the tree hierarchy to split the tree hierarchy into two sections, with a visible indication between the two sections.

According to a third aspect of the invention there is provided a computer program product on a computer readable medium for controlling a data processing system, the computer program product comprising instructions for displaying graphical information in the form of a tree hierarchy comprising a series of nodes, receiving user input, changing the display of the tree hierarchy in response to user input, and, in response to a defined user input, changing the display of the tree hierarchy to split the tree hierarchy into two sections, with a visible indication between the two sections.

Owing to the invention, it is possible to provide a data processing system that provides the user with a display of a tree hierarchy, that more efficiently uses the display area available, while giving the user maximum flexibility to view and access portions of the tree.

In the simplest embodiment, when the user input is an action that would remove the top of the tree hierarchy from view, the processor controls the display to maintain a portion of the top of the tree in view on the display device, and effectively removes a middle portion of the tree hierarchy from view, while introducing a visible indication (such as line across the display device) at the point where the portion of the tree has been removed.

For example, if the display device can show 12 lines of a 20 line tree hierarchy and is currently displaying lines 1 to 12 of the tree, then when the user scrolls down to view line 16, rather than (as in the prior art) displaying lines 4 to 16 on the display device, the processor might control the display device to show lines 1 and 3 and lines 6 to 16 of the tree hierarchy, with the visible indication being introduced between lines 3 and 6 to show that portions of the tree above the visible indication have been removed from view.

Preferably the processor is arranged, when changing the display of the tree hierarchy to split the tree hierarchy into two sections, to control the output of the display device such that a first section of the two sections comprises a path within the tree hierarchy and a second section of the two sections consists of a contiguous portion of the tree hierarchy. This presents the user with a logical and more compact view of the components of the hierarchical tree in which they are interested, without unduly limiting their choices to view other parts of the hierarchical tree. Showing the path (or context) on the display device allows the user to see which portion of the tree hierarchy, at a higher node level, relates to the portion of the tree that they are looking at below the visible indication. Typically the first section will consist of a path within the tree, but may also be a path, plus one or more extra lines of the tree hierarchy, or it may be a path plus a blank line.

In a preferred embodiment, the path in the first section is a path to the first node of the second section. This gives the user the most logical and simplest display of the tree hierarchy.

Advantageously, the processor is further arranged, in response to further user inputs, to control the output of the display device to move the location of the visible indication. The processor is therefore continuously monitoring the user inputs, and moving the visible indication accordingly.

Ideally, the processor is further arranged, to control the output of the display device to include a fragmented scroll bar. The appearance of a fragmented scroll bar, indicating the location of the different parts of the tree hierarchy, will greatly assist the user.

### BRIEF DESCRIPTION OF THE DRAWINGS

Embodiments of the present invention will now be described, by way of example only, with reference to the accompanying drawings, in which:

FIG. 1 is a schematic diagram of a data processing system,

FIG. 2 is a schematic diagram of a display device of the data processing system of FIG. 1,

FIGS. 3 to 6 are schematic diagrams, similar to FIG. 2, of the display device,

FIG. 7 is a flowchart of an algorithm for controlling the display device of the data processing system, and

FIG. 8 is a schematic diagram of a tree hierarchy.

### DESCRIPTION OF THE PREFERRED EMBODIMENTS

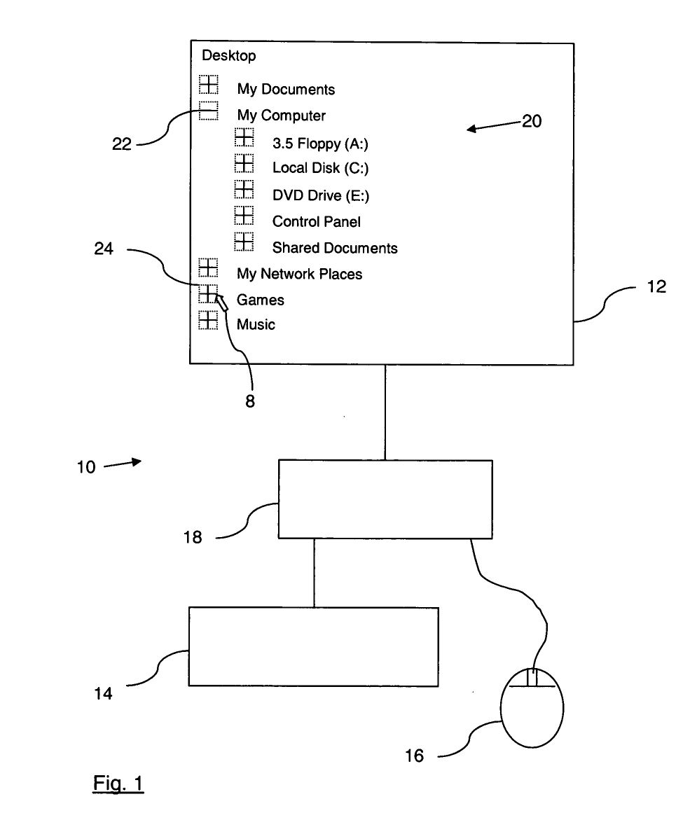

The data processing system 10 of FIG. 1 comprises a display device 12 for displaying graphical information, user interface devices (keyboard 14 and mouse 16) for receiving user input, and a processor 18 communicating with the user interfaces 14 and 16 and with the display device 12. The processor 18 controls the output of the display device 12 and is arranged to display on the display device 12 a tree hierarchy 20 comprising a series of nodes (of which two are indicated by the numerals 22 and 24). The user, via the mouse 16, controls an on-screen cursor 8, in the conventional manner. The display device 12 can display up to twelve lines of the tree hierarchy 20 at any one time. The tree 20, as the display device 12 presently displays it, takes up a total of eleven lines of the display 12.

The processor 18 changes the display of the tree hierarchy 20 in response to user input. For example, the user can click on those nodes that are illustrated with a “+” sign, such as the node 24, to view the sub-nodes that are linked to that particular node; this is often referred to as expanding the hierarchical tree 20. Likewise the user can click on a node illustrated with a “−” sign, such as node 22, to remove from view the sub-nodes of that node. This is the action of contracting the tree. A user can also click on an object directly, such as the “DVD Drive (E:)”, to see the files and folders on that drive (which are typically shown in an adjacent horizontal window, not shown in the Figure for reasons of clarity).

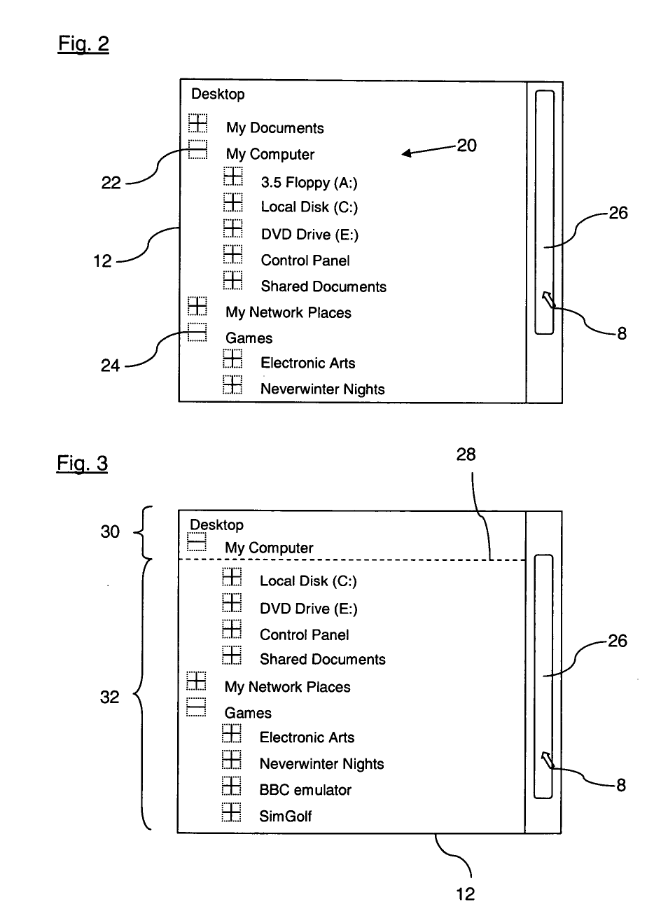

In a first example of the operation of the data processing system 10, the user is assumed to have operated the mouse 16, to click on the node 24 (which relates to the folder entitled “Games”) with the on-screen cursor 8. This will result in the processor 18 controlling the display device 12 to provide the graphical information shown in FIG. 2. The node 24 has changed from a “+” sign to a “−” sign to show that the node 24 is expanded (and can therefore be contracted by clicking on the node 24 again), and the sub-nodes to that node 24, are now shown below that node.

However, since the hierarchical tree 20 has been expanded to a number of lines greater than twelve, which is larger than the available display area on the display device 12, a scroll bar 26 is displayed on the right hand side of the display area. The user does not know how many lines the hierarchical tree 20 now takes up, but the size of the scroll bar 26 relative to the size of the display device 12 gives them an indication of the amount of the tree 20 that is currently unseen.

Continuing this example, since the user cannot see the entire contents of the folder “Games” (or at least cannot be sure that they can see the entire contents), they will naturally use the scroll bar 26 with the cursor 8 to move the hierarchical tree 20 upwards on the display device 12. In a conventional arrangement (such as the standard Windows Explorer application), this would result in a simple scrolling upwards of the hierarchical tree 20.

However, here the processor 18 is further arranged, in response to the defined user input of scrolling some information off the top of the display device 12, to change the display of the tree hierarchy 20 to split the tree hierarchy into two sections 30 and 32, with a visible indication 28 between the two sections 30 and 32. This is shown in FIG. 3. The visible indication 28 is a simple horizontal line across the display 12 to illustrate to the user, that the two sections 30 and 32 are no longer a contiguous portion of the hierarchical tree 20.

In the display of the tree 20 in the view shown in FIG. 3, the user is now able to see two more sub-nodes of the node “Games”, so that they are now able to see a total of four sub-nodes of that node. The position of the scroll bar 26 has been adjusted, as it has been moved down by the user, using the mouse 16 to control the cursor 8. The processor 18 is arranged, when changing the display of the tree hierarchy 20 to split the tree hierarchy 20 into two sections 30 and 32, controlling the output of the display device 12 such that the second section 32 of the tree 20 consists of a contiguous portion of the tree hierarchy 20.

The display device 12 is still showing twelve lines of the tree hierarchy, and so there has been no reduction in the amount of information that the display 12 is showing. The user now has the additional information on the display device 12 that the node “Games” is in the directory “Desktop”. The user can also see the node “My Computer”, which allows him to see the node that contains the sub-nodes “Local Disk (C:)” etc. All of this information would have been lost in the conventional arrangement for controlling the display of the hierarchical tree 20. It will be appreciated, that in a practical embodiment of the invention, with a larger screen and much larger hierarchical tree, the ability of the user to see the nodes and sub-nodes that have led to the current portion of the tree that they are looking at, is very advantageous.

The processor 18 is arranged, when changing the display of the tree hierarchy 20 to split it into two sections 30 and 32, to control the output of the display device 12 such that the first section 30 consists of a path within the tree hierarchy 20. In the example illustrated in FIG. 3, the path is very simply “Desktop” with the node “My Computer”, which shows the location of the node “Games”. As the user further accesses the tree hierarchy 20, the path will adapt to the changes. This is discussed in more detail below.

The user can navigate through the tree hierarchy 20 on the display device 12 shown in FIG. 3, as they would the tree 20 shown in FIG. 1, which is not split into two sections. In the tree 20 of FIG. 3, with two sections 30 and 32, the user can expand or contract nodes, and can select directly, via the mouse 16 and cursor 8, objects that are above the visible indication 28 in the first section 30, as well as objects in the lower section 32, as desired. The user can also use the scroll bar 26 to continue to move the view of the tree 20 up or down. If the user were to move the scroll bar 26 upwards so that it would return to its upper most position, then the processor 18 would control the display device 12 so that the visible indication 28 would be removed, and the view on the display device 12 would return to that shown in FIG. 2, with a single contiguous section of the tree hierarchy 20 being shown on the twelve lines of the display device 12.

If the user were to continue to expand the tree hierarchy 20 and scroll further down the tree 20 with the scroll bar 26, then the position of the visible indication 28 and the contents of the first section 30 that is above the visible indication 28 on the display device 12 will change. The processor 18 is arranged to continuously change the tree hierarchy 20 on the display device 12 in response to the changes that the user makes.

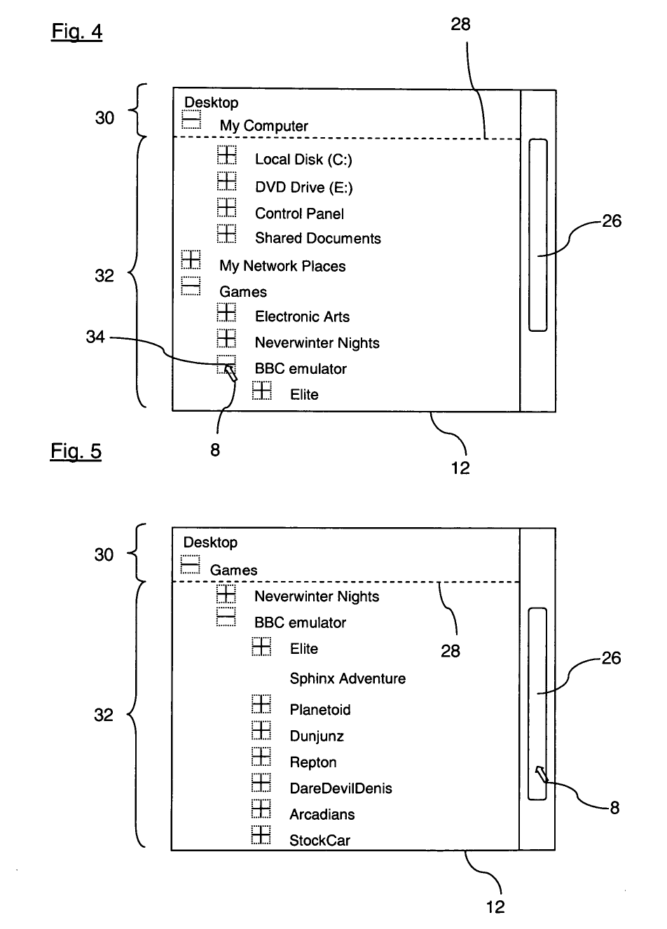

FIGS. 4 and 5 show further the adaptations to the view of the tree hierarchy 20 on the display device 12, which would be made by the processor 18, in response to specific inputs from the user via the mouse 16. In FIG. 4 the user has moved the cursor 8 to the sub-node 34, which is the sub-node “BBC emulator” and expanded that sub-node 34 to view the contents of that object, which is a folder of files. In the conventional working of applications such as Windows Explorer each object is accompanied by an icon indicating the type of object, so a small yellow folder is present for folders, etc. These have been omitted from the views of the display device 12 for reasons of clarity.

That sub-node 34 has changed from a “+” sign to a “−” sign to show to the user that this sub-node 34 has been expanded, and the first sub-sub-node to the sub-node “BBC emulator” has appeared, being the sub-sub-node “Elite”. The scroll bar 26 has reduced in size, to indicate to the user that the overall size of the tree 20 has increased, and that they are therefore viewing a relatively smaller portion of the tree 20, than they were in the past, although twelve lines of the tree 20 are still visible on the display device 12.

Typically, the user at this point would like to scroll down, using the scroll bar 26 to see further contents of the sub-node 34. After they have scrolled down a certain distance, then the view on the display device 12 would be as shown in FIG. 5. The processor 18 is arranged, in response to this user input, to change the display of the tree hierarchy 20, maintaining the split of the tree hierarchy 20 into two sections 30 and 32, with a visible indication 28 between the two sections 30 and 32, but with adjustment to the objects above the visible indication 28 to take account of the change that the user has made. This is explained in detail in the passage that follows.

At first, as the user scrolls down, each line in the tree hierarchy 20 that is directly below the visible indication 28 will disappear, to be replaced at the bottom, by a new line in the tree 20. For instance, the first action that the processor 18 would take would be to remove the node “Local Disk (C:)”, move upwards the other nodes below the indication 28 and add at the bottom the new sub-sub-node “Sphinx Adventure” (note that this node does not have a “+” or “−” symbol adjacent to it, which indicates that it has no sub-nodes).

This action will continue, while the user is scrolling, until the node “Games” becomes the last line below the indication 28. At this point as the user scrolls downwards (moving the tree 20 upwards), the node “Games” will not be deleted, but will be moved above the indication 28 by the processor 18, replacing the node “My Computer”. In this way the user does not lose the context in relation to the information on the display device 12 that they are actually viewing.

The processor 18 is arranged, in this preferred embodiment, when changing the display of the tree hierarchy 20, while it is split into two sections 30 and 32, to control the output of the display device 12 such that the first section 30 always consists of a path within the tree hierarchy 20. The path shows the user the context of the current objects they are looking at in the lower portion of the display 12. The processor 18 is also arranged, when changing the display of the tree hierarchy, to control the output of the display device 12 such that the second section 32 always consists of a contiguous portion of the tree hierarchy 20.

As the user makes further selections and expansions within the tree hierarchy 20, then the processor 18 further adapts the display of the tree on the display device 12. Typically, as the user goes deeper into the tree 20 by opening sub-nodes of sub-nodes, and scrolling through the tree 20, then more lines of the display will appear above the visible indication 28.

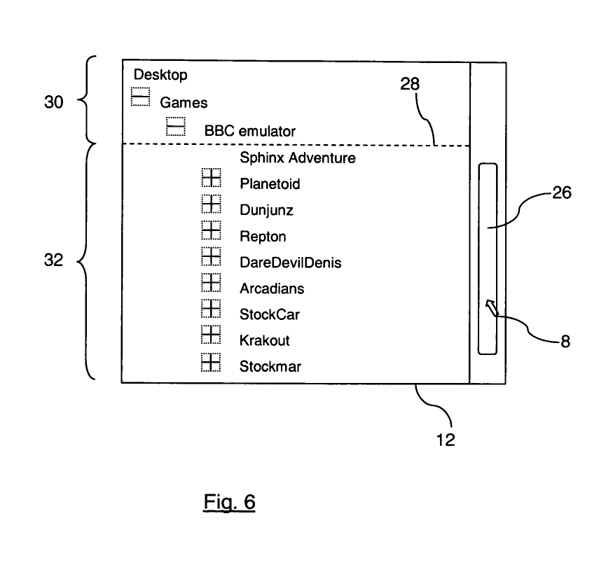

FIG. 6 shows the view that the user would see on the display device 12, after the user has moved the scroll bar 26 further down, which moves the portion of the tree hierarchy shown in the lower portion 32 of the display 12 upwards. In a similar fashion as happened when the user moved from the view of FIG. 4 to FIG. 5, as the user scrolls down, viewing more sub-sub-nodes of the sub-node “BBC emulator”, the processor 18 controls the display device 12 to remove lines immediately below the indication 28, until it reaches a point where in order to maintain the context for the user, it is necessary to move the visible indication 28 down a line, eventually ending up with the view of FIG. 6. The first section 30 has increased in size by one display line, and the second section 32 has decreased correspondingly.

In the view of FIG. 6, the display device 12 is now controlled, by the processor 18, to show three lines of the hierarchical tree 20 above the indication 28, and to show nine lines below the indication 28. The upper section 30 of the display 12 shows the context (path) to the portion shown in the lower section 32 of the display 12. It should be noted that while the lower section 32 does display a contiguous portion of the tree 20, the upper portion does not, as it shows the nodes and sub-nodes that lead to the part of the tree 20 that is shown in the lower portion of the display 12. For example, in FIG. 6, in the upper portion 30 the node “Games” is displayed next to the sub-node “BBC Emulator”, however, as can be seen from FIG. 4, these two nodes do not form a contiguous portion of the tree 20, as there are two sub-nodes (“Electronic Arts” and “Neverwinter Nights”) between them. In the lower portion, it is not possible to arrange the tree 20, via any combination of user actions on the tree hierarchy 20, that would lead to these two nodes being next to each other.

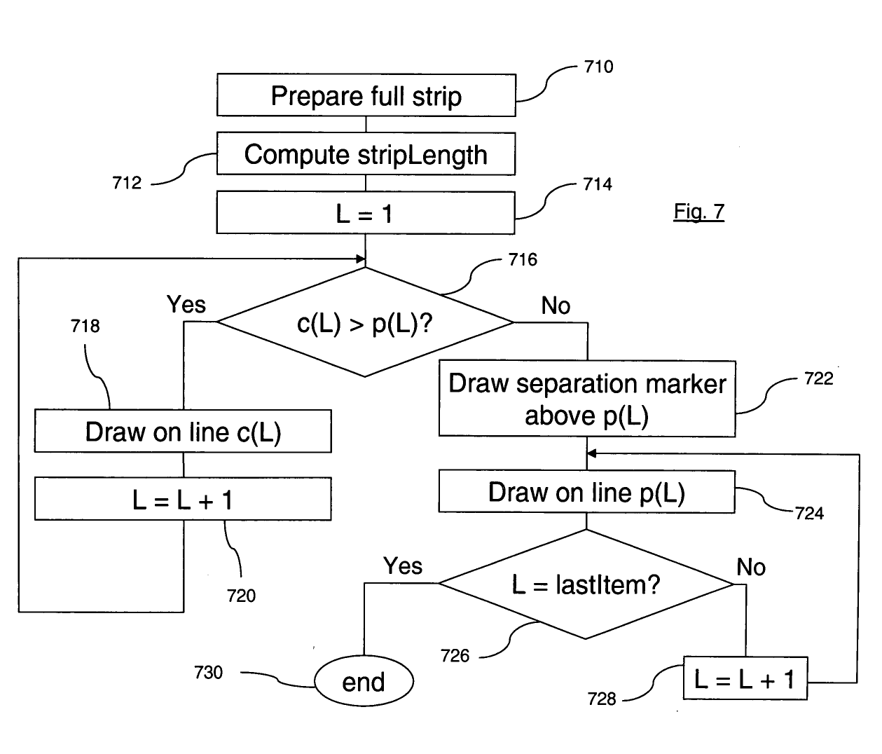

FIG. 7 illustrates the algorithm that the processor 18 is using when it is controlling the display device 12. This algorithm is designed for the simplest understanding of the invention, and intentionally is not optimised from a computational perspective. In running the algorithm, the following variables are used:

stripLength

screenHeight

lastItem.

The three variables are explained as follows. The variable stripLength is the number of lines that the tree hierarchy 20 would occupy, if it were possible to display its full current length (this is not the same as the maximum possible size of the tree 20, the stripLength is the length that the tree 20 has, given the current expansions and contractions of nodes and sub-nodes). The variable screenHeight is the number of lines that it is possible to display on the display device 12. The variable lastItem is the point in the currently expanded tree 20 at which the last item (object) to display is located.

To illustrate the operation of the algorithm by the processor 18, an example will be explained with reference to the view shown in FIG. 3. In the view that is to be displayed by the display device 12, the variable screenHeight=12, and the variable stripLength=15 (the eleven nodes and sub-nodes shown in FIG. 1, plus the four sub-nodes that have been revealed by the expansion of the node “Games”), and the value of the variable lastItem=14 (this is the number of the sub-node “SimGolf” in the current structure of the tree 20, the final node is “Music”).

The algorithm driven by the processor 18 effectively receives a tree 20 of a certain length and writes that tree 20 into a memory that has the (shorter) length of the number of lines of the display device 12. Some overwriting may occur during this process, but this will be come clear, as the explanation of the example is continued.

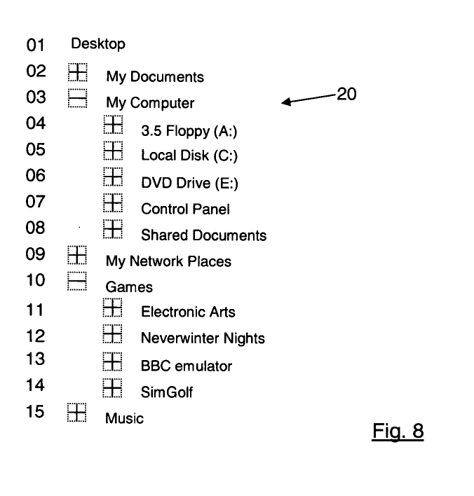

FIG. 8 illustrates the full strip length of 15 nodes and sub-nodes that the processor 18 is going to compute into the view seen in FIG. 3. The nodes and sub-nodes in the tree 20 are numbered, down the left hand side, for clarity of explanation. In the algorithm of FIG. 7, the first step 710, labelled as prepare full strip, is the preparation (in memory) of the tree 20 as shown in FIG. 8. The second step 712 is to compute the stripLength; as already stated, this is 15.

The algorithm then effectively has two loops that it goes through, cycling through the left hand loop until it reaches a certain point and then switching to the right hand loop, which is repeated, until the processing of the algorithm is at an end. The algorithm cycles through the loops using a counting variable L, which at step 714 is set to 1. The algorithm then passes to the decision box 716, which compares the values generated by two function c(L) and p(L). These functions are as follows:

p(L)=L+screenHeight−lastItem

c(L)=depth(L).

The first function p(L) is a relatively straight forward numerical function. When L=1, the value of p(L)=1+12−14=−1. The second function c(L) is designed to return the value of the depth of the object at that line in the full tree 20 of FIG. 8. The “depth” of an object is its position in the hierarchy, so, for example, “Desktop” has a depth of 1, all the nodes, such as “My Documents” have a depth of 2, all the sub-nodes, such as “3.5 Floppy (A:)” have a depth of 3 and so on. In the view shown in FIG. 8, as the nodes and sub-nodes are at lower depth they move one indentation to the right. This is the conventional manner of displaying a tree hierarchy 20. Therefore, the value of c(1)=1, since the node 01 “Desktop” has a depth of 1. Since, when L=1, c(1)>p(1), the decision box 716 passes the algorithm to box 718, which draws object L (“Desktop”) on line c(L); L=1 and c(1)=1, so this drawn on line 1. The algorithm then moves to box 720, L is incremented to 2 and the algorithm is returned to the decision box 716.

As before, at box 716, the values of c(L) and p(L) are compared. When L=2, p(L)=0 and c(L)=2 (the depth of “My Documents” being 2), so the algorithm again moves to box 718 and draws “My Documents” on line 2. As will be appreciated, from the view shown in FIG. 3 of the tree hierarchy 20, this is not the correct object to be shown on that line. As stated above, the “drawing” of the objects that make up the tree 20, takes the form of writing the objects into a display memory buffer that has a number lines equal to the number of lines available on the display device 20. As the algorithm proceeds, some elements in the memory buffer are overwritten.

The value of L is then raised to 3, and the algorithm returns to box 716. When L=3, p(L)=1 and c(L)=2, so the algorithm again moves to box 718 and draws “My Computer” on line 2, overwriting the entry “My Documents”. The box 718 draws object L on line c(L), and the value of c(3)=c(2)=2.

L is then incremented to 4, and the algorithm returns to box 716. When L=4, p(L)=2 and c(L)=3 (the depth of node 04 “3.5 Floppy (A:)”). The algorithm moves to box 718 and draws “3.5 Floppy (A:)” on line 3. L is then incremented to 5 and the algorithm moves to box 716. At this point in the calculation, when L=5, p(L)=3 and c(L)=3 (the depth of the node 05). It is therefore no longer the case that c(L)>p(L) so the algorithm moves to the box 722, which is the instruction to draw the visible indication 28 (referred to as a separation marker) above line p(L). Since p(L) is 3 the visible indication 28 is drawn between lines 2 and 3, as can be seen in FIG. 3.

The algorithm then moves to box 724, which is the instruction to draw node L onto line p(L). L=5, and so node 05 (“Local Disk (C:)”) is drawn on line 3 (p(5) being equal to 3). From the explanation of the working of the algorithm of FIG. 7, it can be seen how the processor 18 builds up the view shown in FIG. 3, for display by the display device 12.

The algorithm moves on to box 726 to check if L=lastItem. If not then it moves to box 728, which increments L by 1 and moves back to box 724, which now draws node 06 on line 4. The algorithm continues looping round the boxes 724, 726 and 728, drawing the remaining lines of the hierarchical tree 20 until L=lastItem, at which point the algorithm terminates at box 730. In this way, the processor 18 runs the algorithm to determine which objects in the tree 20 are placed above the visible indication 28 and which are placed below the indication 28, and also exactly which object are to be selected to be placed above the indication 28.

As the user continues to make choices that alter the appearance of the tree 20, then the processor 18 continues to execute the algorithm to decide which line in the hierarchical tree 20 is placed where, and the location of the visible indication 28. The processor 18 is also arranged to monitor the size of the top portion 30, to ensure that, where the maximum tree structure depth is very high (at worst exceeding the number of lines available for display), the display device 12 is arranged to display only a limited subset of the context potion 30. This may be just the top of the path, the bottom of the path, or a few lines from each.

The processor 18 is also arranged so that, if the user desires, it can control the display device 12 to display the scroll bar 26 in a non-conventional manner. As a user option, the display device 12 can be controlled to show the scroll bar 26 as a fragmented set of bars rather than the conventional solid block (as in FIG. 2 for example). Each fragment of the scroll bar that is shown will correspond to a particular fragment of the tree hierarchy that is shown in the main window. In practice, this will result in a small number of small fragments (representing the path shown in the upper portion 30) above a larger continuous bar (representing the contiguous portion of the tree shown in the lower portion 32).

It will be appreciated by a man of ordinary skill that the algorithm detailed in the specific example above, is one of many different ways of controlling the output of the display device 12, to achieve the end of displaying the tree hierarchy such that, when the tree is too large for display on the display device, a portion of the tree is removed, and replaced with a visible indication to show that a portion has been removed, and the location of that removed portion. In more complicated views of the tree hierarchy, it is possible to provide more than one visible indication in the view of the tree, to indicate that more than one section has been removed from the tree.

An alternative algorithm for computing which lines of the tree are to be displayed, and in what order, uses a third function, parent(x,y). This function returns the number of the node that is the parent of node x at depth y. So for example, using the tree 20 displayed in FIG. 8, parent(13,2)=10, because the parent of node 13 “BBC emulator” at depth 2 is the node 10 “Games”.

The alternative algorithm starts with a value of L=lastItem−screenHeight+1 and increments L=L+1 until c(L)>=p(L). In the example of FIGS. 8 and 3, this will be the node “Local Disk (C:)” which is then drawn at line 3. At this point the algorithm draws the visible indication 28 above this line and fills up the remainder of the screen below this line with a contiguous portion of the tree 20 of FIG. 8. To complete the tree above the visible indication, the algorithm switches to using the parent function to find the parents of the node “Local Disk (C:)” and draws those nodes above the visible indication. In this example, the algorithm computes parent(5,2) and parent(5,1) (5 being the number of the node “Local Disk (C:)”) and draws those nodes in at lines 2 and 1 respectively.

With both this algorithm that uses the parent function, and the algorithm of FIG. 7, there is always the possibility of having one more free line above the visible indication 28 than is actually required to draw the path in the top section 30 to the first node of the bottom section 32. For example, this occurs in the second algorithm when c(L)>p(L). How this edge condition is handled is not material; in the first algorithm an extra line, in addition to the path, is provided in the first section 30, and in the second algorithm, a blank line will appear above the visible indication 28.

It is sometimes possible to compute sufficient information about the full strip to make a correct display without completely evaluating the full strip.

In known systems, and in the algorithms above, it is not always necessary compute the complete full strip, or even to determine exactly its size and the scroll position within that size. For example, if a large remote directory is expanded, it is desired to paint the first few items and there is no need to compute exactly how many items there are. In this case, a fuzzy guess is made of the length of that directory and used to drive the display and scrolling. If the user does scroll down, then this fuzzy information may be refined. By the time the end of the directory is reached, the information is no longer fuzzy.

The two algorithms described above (preferred and alternative) are arranged to ensure that there is smooth scrolling on the screen (except at the boundary between the top and bottom parts). It will be necessary sometimes to jump to an exact position within the full strip, e.g. initial display is given a start point (as with start Explore All Users jumping directly to “C:\Documents and Settings\All Users\Start Menu), or an expansion of a large item forces a jump to display more useful information {e.g. after opening Explore All Users, expand ‘Programs’}, or a new path is typed into the address bar.

An appropriate algorithm to display information directly after a jump (if the user has jumped to line JL) is as follows: display required first line JL on screen line c(JL), draw visible indication above JL, paint bottom portion of screen as in preferred algorithm (right hand loop of FIG. 7), for the top of the display down to depth(JL) draw info for parent(JL,sl) on screen line sl. Once the jump has been made and displayed this will determine lastItem. Normal scrolling will then revert to the preferred algorithm or its alternative.

1. A computer implemented method, comprising:
displaying a tree hierarchy comprising a plurality of nodes;
receiving a first user input;
in response to the first user input, splitting the tree hierarchy into first and second sections; and
displaying a visible indication between the first and second sections.

2. The computer implemented method according to claim 1, wherein the first section comprises a path within the tree hierarchy.

3. The computer implemented method according to claim 2, wherein the path in the first section leads to the first node of the second section.

4. The computer implemented method according to claim 1, wherein the second section comprises a contiguous portion of the tree hierarchy.

5. The computer implemented method according to claim 1, further comprising:
receiving a second user input; and
moving the location of the visible indication.

6. The computer implemented method according to claim 1, further comprising displaying a fragmented scroll bar.

7. A computer readable medium embodying computer program code, the computer program code comprising computer executable instructions configured to:
display a tree hierarchy comprising a plurality of nodes;
receive a first user input;
in response to the first user input, split the tree hierarchy into first and second sections; and
display a visible indication between the first and second sections.

8. The computer readable medium according to claim 7, wherein the first section comprises a path within the tree hierarchy.

9. The computer readable medium according to claim 8, wherein the path in the first section leads to the first node of the second section.

10. The computer readable medium according to claim 7, wherein the second section comprises a contiguous portion of the tree hierarchy.

11. The computer readable medium according to claim 7, wherein the embodied computer program code further comprises computer executable instructions configured to:
receive a second user input; and
move the location of the visible indication.

12. The computer readable medium according to claim 7, wherein the embodied computer program code further comprises computer executable instructions configured to display a fragmented scroll bar.

13. A data processing system, comprising:
a display device for displaying graphical information;
a user interface device for receiving user input; and
a processor coupled to the display device and to the user interface device, wherein the processor is configured to:
display a tree hierarchy comprising a plurality of nodes;
receive a first user input;
in response to the first user input, split the tree hierarchy into first and second sections; and
display a visible indication between the first and second sections.

14. A data processing system according to claim 13, wherein the first section comprises a path within the tree hierarchy.

15. A data processing system according to claim 14, wherein the path in the first section leads to the first node of the second section.

16. A data processing system according to claim 13, wherein the second section comprises a contiguous portion of the tree hierarchy.

17. A data processing system according to claim 13, wherein the processor is further configured to:
receive a second user input; and
move the location of the visible indication.

18. A data processing system according to claim 13, wherein the processor is further configured to display a fragmented scroll bar.
